(19) United States
(12) Patent Application Publication
(10) Pub. No.: US 2007/0064970 A1
(43) Pub. Date: Mar. 22, 2007

(54) Telescopic speaker box, and audio player and electronic apparatus using the same

(75) Inventors: Hsien-Min Yang, Tao Yuan Shien (TW); Hui-Ju Yang, Taoyuan City (TW); Tui-Yang Tsai, Tao Yuan Shien (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/518,436

(22) Filed: Sep. 11, 2006

(30) Foreign Application Priority Data
Sep. 21, 2005 (TW) 94132724

(51) Int. Cl. H04R 1/02

(52) U.S. Cl. 381/388

(57) ABSTRACT

A telescopic speaker box, and an audio player and an electronic apparatus using the same are provided. The audio player comprises a loudspeaker unit and a telescopic speaker box. The telescopic speaker box comprises a speaker box housing whose volume is adjustable. The speaker box housing has a hole. The hole is used for receiving the loudspeaker unit. By adjusting the volume of the speaker box housing, a lowest resonant frequency of the telescopic speaker box can be achieved.

This application claims the benefit of Taiwan application Ser. No. 94132724, filed Sep. 21, 2005, the subject matter of which is incorporated herein by reference.

### BACKGROUND OF THE INVENTION

1. Field of the Invention

The invention relates in general to a speaker box, and an audio player and an electronic apparatus using the same, and more particularly to a telescopic speaker box, and an audio player and an electronic apparatus using the same.

2. Description of the Related Art

With the increasing demand in multi-media effect of electronic product, current notebook computers are designed to have multi-functions. For example, a loudspeaker is built in a notebook computer to play music or various sound effects.

Referring to FIG. 1, the auditory influence under various frequency regions is illustrated. In terms of hearing, the sound possesses three characteristics: loudness, pitch and timbre. The loudness of the sound is determined according to the amplitude of sound wave The pitch of the sound is determined according to the frequency of the sound, and different frequency regions give the hearer different senses of hearing. For example, the sound of low frequency region sounds heavy and deep, while the sound of high frequency region sounds clear and fine. The timbre of the sound is determined according to the harmonic waves of the sound and the relationship between the waves. Normally, the frequency audible to humans is within the range of 20˜20 KHz, and whatever frequency outside the audible frequency range is not audible to the hearer. The loudness audible to humans is within the range of −5˜130 dB, and whatever sound below −5 dB is not audible to the hearer, and whatever sound over 130 dB would make the hearer uncomfortable or feel pain at the ears.

The notebook computer converts electronic signals into sounds and then the sound is played by a loudspeaker. The range of the sound audible to humans is determined according to the lowest resonant frequency of the loudspeaker. The lowest resonant frequency of the loudspeaker is determined according to the size of the speaker box. The larger the speaker box is the lower the lowest resonant frequency of the loudspeaker, and the broader the range of the sound auditable to the hearer will be. To the contrary, the smaller the speaker box is, the higher the lowest resonant frequency of the loudspeaker, and the narrower the range of the sound auditable to the hearer will be.

However, the internal space inside a notebook computer is limited, hence restricting the size of the speaker box. Take the current notebook computer for example, the lowest resonant frequency of the built in loudspeaker is approximately within the range of 350˜500 Hz, which can be classified as middle to low frequency regions. For the sound whose frequency below 350 Hz to become audible and clear to the hearer, part of the sound frequencies needs to be adjusted and outputted by an equalizer of the media player software. Despite there are dozens of equalizers embedded in the operating system of the computer available to be used, however, the characteristics of the loudspeaker do not change at all, so the quality of the sound generated by the loudspeaker still can not be effectively improved. The speaker box used in the conventional notebook computer is unable to make the hearer feel the bass effect of heaviness and deepness with respect to the sound within middle to low frequency regions.

### SUMMARY OF THE INVENTION

It is therefore an object of the invention to provide a telescopic speaker box, and an audio player and an electronic apparatus using the same. By adjusting the volume of the speaker box, the lowest resonant frequency of the speaker box can be achieved.

The invention achieves the above-identified object by providing an audio player. The audio player comprises a loudspeaker unit and a telescopic speaker box. The telescopic speaker box comprises a speaker box housing whose volume is adjustable. The speaker box housing has a hole. The hole is used for receiving the loudspeaker unit. By adjusting the volume of the speaker box housing, the lowest resonant frequency of the telescopic speaker box can be achieved.

The invention further achieves the above-identified object by providing an electronic apparatus. The electronic apparatus comprises an electronic apparatus body, a loudspeaker unit and a telescopic speaker box. The telescopic speaker box is disposed on one side of the electronic apparatus body. The telescopic speaker box comprises a speaker box housing whose volume is adjustable. The speaker box housing has a hole. The hole is used for receiving the loudspeaker unit. By adjusting the volume of the speaker box housing, the lowest resonant frequency of the telescopic speaker box can be achieved.

The invention further achieves the above-identified object by providing a telescopic speaker box. The telescopic speaker box comprises a speaker box housing whose volume is adjustable. The speaker box housing has a hole. The hole is used for receiving the loudspeaker unit. By adjusting the volume of the speaker box housing, the lowest resonant frequency of the telescopic speaker box can be achieved.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates the auditory influence under various frequency regions;

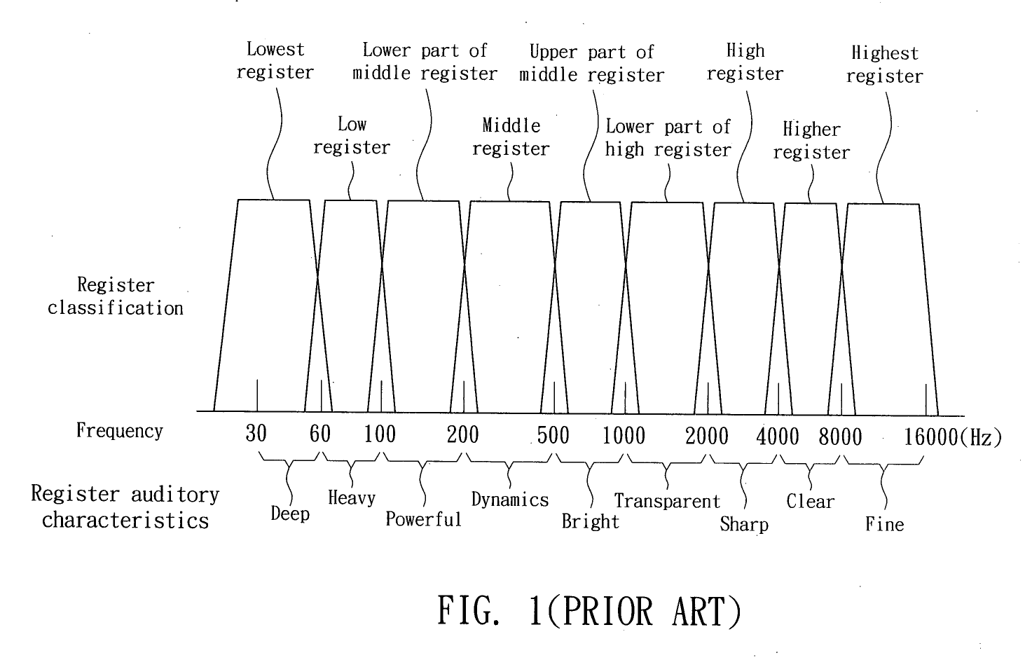

FIG. 2A schematically illustrates a speaker box being at an unextended state according to a first embodiment of the invention;

FIG. 2B schematically illustrates a speaker box being at an extended state according to the first embodiment of the invention;

FIG. 3 illustrates a structural diagram of the speaker box according to the first embodiment of the invention;

FIG. 4A schematically illustrates a speaker box being at an unextended state according to a second embodiment of the invention; and

FIG. 4B schematically illustrates a speaker box being at an extended state according to the second embodiment of the invention.

### DETAILED DESCRIPTION OF THE INVENTION

Living in today's society when fastness and convenience are important, the electronic apparatus which is equipped with an audio player and possesses the features of slimness, lightweight, smallness and compactness is gaining greater and greater popularity. Examples of the audio player include a loudspeaker. Examples of the electronic apparatus include a notebook computer. The internal space of the electronic apparatus is limited, hence restricting the size of the speaker box of the audio player. If a telescopic speaker box is used to increase the lowest resonant frequency of the audio player, the hearer will be able to hear the sound of middle to low frequency regions as well as the effect of the bass which is heavy and deep.

The lowest resonant frequency of the audio player is determined by various important factors of the loudspeaker unit shown in Table One as well as various important factors of the speaker box shown in Table Two. For the audio player to achieve quality bass effect, the loudspeaker unit needs to satisfy the following conditions. Firstly, the equivalent mass M_{O} of the vibration system needs to be as large as possible. Secondly, the lowest resonant frequency F_{O} of the loudspeaker unit needs to be as low as possible. Thirdly, the effective diameter (2a) of the loudspeaker needs to be as small as possible. Fourthly, the magnetism of the magnet needs to be as strong as possible.

TABLE ONE
Important Factors Of The Loudspeaker Unit

Lowest resonant frequency (F_{O})
Equivalent mass of the Vibration system (M_{O})
Equivalent volume (V_{Eq})
Vibration system (Q_{O})
Effective radius of the loudspeaker (a)
Effective vibration area of vibration diaphragm (A_{O})

TABLE TWO
Important Factors Of The Speaker Box

Equivalent volume of the speaker box (V_{BE})
Nominal impedance
Lowest resonant frequency (F_{BO})
Power rating
Mean sound pressure level (Mean S.P.L.)
Polarity

Moreover, for the audio player to achieve better bass effect, various important factors of the speaker box as shown in Table Two need to be taken into consideration. The electronic apparatus being subject to the restriction of internal space can only provide limited space for the speaker box of the audio player. Typically, the speaker box is categorized into three types, namely, the reflection type speaker box, the close-type speaker box and the transmission type speaker box. The designs of the three types of speaker box are elaborated below.

Take the close-type speaker box for example. Since the air inside the close-type speaker box is working like a spring for the audio player, the lowest resonant frequency F_{BO} of the speaker box will be higher than the lowest resonant frequency F_{O} of the loudspeaker unit. The design of the close-type speaker box needs to take the following five important factors into account:

The first factor is the volume V_{B} of the close-type speaker box. When F_{BO}, V_{Eq} and F_{O} are known, the volume V_{B} of the close-type speaker box is expressed as:

$$\frac{{F}_{O}}{{F}_{BO}} \approx \frac{{V}_{Eq}}{{V}_{B}} ⇒ {V}_{B} \approx \frac{{F}_{BO} ( Hz ) \times {V}_{Eq} ( {cm}^{3} )}{{F}_{O} ( Hz )} ( {cm}^{3} )$$

The second factor is the quality factor Q_{B} of the close-type speaker box. When F_{BO}, Q_{O} and F_{O} are known, the quality factor Q_{B} of the close-type speaker box is expressed as:

$$\frac{{F}_{O}}{{F}_{BO}} \approx \frac{{Q}_{O}}{{Q}_{B}} ⇒ {Q}_{B} \approx \frac{{F}_{BO} \times {Q}_{O}}{{F}_{O}}$$

The third factor is an elasticity ratio a between the loudspeaker unit and the close-type speaker box. When Q_{O} and Q_{B} are known, the elasticity ratio α between the loudspeaker unit and the close-type speaker box is expressed as:

$$α = {( \frac{{Q}_{B}}{{Q}_{O}} )}^{2} - 1 \approx {( \frac{{F}_{BO}}{{F}_{O}} )}^{2} - 1$$

The fourth factor is the effective volume V_{BE} of the close-type speaker box. When a, α, M_{O} and F_{O} are known, the effective volume V_{BE} Of the close-type speaker box is expressed as:

$${V}_{BE} \approx \frac{355 \times {a}^{4} ( cm )}{α \times {F}_{O}^{2} ( Hz ) \times {M}_{O} ( g )} ( {cm}^{3} )$$

The fifth factor is the lowest resonant frequency F_{BO} of the close-type speaker box. When V_{B}, a, M_{O} and F_{O} are known, the lowest resonant frequency F_{BO} of the close-type speaker box is expressed as:

$${F}_{BO} \approx \sqrt{{F}_{O}^{2} ( Hz ) + \frac{355 \times {a}^{4} ( cm )}{{M}_{O} ( g ) \times {V}_{B} ( {cm}^{3} )}} ( Hz )$$

Take the reflection type speaker box for example. The reflection type speaker box has excellent performance in low-pitched sounds, making the hearer feel that the sound is stretched out. Under the conditions with the same volume of the speaker box, the lowest frequency of the reflection type speaker box is lower than the lowest frequency of the close-type speaker box by 60%. To meet the same requirement of the lowest frequency, the volume of the reflection type speaker box only needs to be 60% of the volume of the close-type speaker box. Therefore, the reflection type speaker box can achieve rich bass effect by using a small-sized speaker box. However, the design of the reflection type speaker box needs to take the following three important factors into account.

The first factor is the relationship between the harmonic frequency of the reflective duct and the Q_{O} value. The Q_{O} value of the loudspeaker unit suitable for the reflection type speaker box ranges from 0.2˜0.62, it is unsuitable for the reflection type speaker box while the Q_{O} value of the loudspeaker unit is below or over the above range. The relationship between the harmonic frequency F_{OT} (or referred as “the lowest resonant frequency”) of the reflective duct and the Q_{O} value is illustrated in Table Three:

TABLE THREE

| Q_{O} | F_{OT} | Q_{O} | F_{OT} |
|---|---|---|---|
| 0.20 | F_{O} × 1.8 | 0.22 | F_{O} × 1.6 |
| 0.25 | F_{O} × 1.5 | 0.28 | F_{O} × 1.3 |
| 0.30 | F_{O} × 1.2 | 0.32 | F_{O} × 1.2 |
| 0.35 | F_{O} × 1.1 | 0.38 | F_{O} × 1.0 |
| 0.40 | F_{O} × 1.0 | 0.42 | F_{O} × 0.9 |
| 0.45 | F_{O} × 0.9 | 0.48 | F_{O} × 0.8 |
| 0.50 | F_{O} × 0.8 | 0.52 | F_{O} × 0.75 |
| 0.55 | F_{O} × 0.7 | 0.58 | F_{O} × 0.7 |
| 0.60 | F_{O} × 0.65 | 0.62 | F_{O} × 0.65 |

The second factor is the volume of the reflection type speaker box. The volume of reflection type speaker box is expressed in the same formula with the volume of the close-type speaker box, that is:

$${V}_{BE} \approx \frac{355 \times {a}^{4} ( cm )}{α \times {F}_{O}^{2} ( Hz ) \times {M}_{O} ( g )} ( Hz ) , \\ wherein$$

$$α = {( \frac{{Q}_{B}}{{Q}_{O}} )}^{2} - 1 \approx {( \frac{{F}_{BO}}{{F}_{O}} )}^{2} - 1 ,$$

typically, the α value ranges from 1˜2 according to the design of the reflection type speaker box.

The third factor is the length L of the reflective duct. In order to determine the length of the reflective duct, the volume of the speaker box V_{BE}, the lowest resonant frequency F_{TO} of the reflective duct and the hole area A_{T} of the reflective duct must be determined first. The hole area A_{T} of the reflective duct is normally equal to ½, ¼, ⅛, 1/16, or ½ⁿ times the effective vibration area of the vibration diaphragm A_{O}, wherein n is a positive integer. The shape of the hole is rectangular or circular. The same hole area will produce the same reflection effect. The length L of the reflective duct is expressed as:

$$L = \frac{30000 \times {A}_{T} ( {cm}^{2} )}{{F}_{TO}^{2} ( Hz ) \cdot {V}_{BE} ( {cm}^{3} )} - 0.825 \sqrt{{A}_{T} ( {cm}^{2} )} ( cm )$$

Take the transmission type speaker box for example. The design of the transmission type speaker box needs to take the following four important factors into account:

The first factor is the volume of the transmission type speaker box. The volume of the transmission type speaker box is expressed in the same formula with the volume of the close-type speaker box, that is:

$$\frac{{F}_{O}}{{F}_{BO}} \approx \frac{{V}_{Eq}}{{V}_{B}} ⇒ {V}_{B} \approx \frac{{F}_{BO} ( Hz ) \times {V}_{Eq} ( {cm}^{3} )}{{F}_{O} ( Hz )} ( {cm}^{3} )$$

The second factor is the wavelength λ of the system. When the frequency is equal to “the lowest resonant frequency F_{BO} of the system” as requested by the consumer, the wavelength λ of the system is expressed as:

$$λ = \frac{344 ( \text{m/sec} ) \times 1000 ( \text{cm/m} )}{{F}_{ BO} ( Hz )} ( cm )$$

The third factor is the length L of the audio duct. The length L of the audio duct is equal to ¼, ⅛, or 1/16 times the wavelength λ of the system. According to the experimental experience, the audio duct does not have good performance when the length is smaller than 1/16times the wavelength of the system. The length L of the audio duct is expressed as:

$$L = X \times λ ( cm ) ( cm ) ; X = \frac{1}{4} , \frac{1}{8} , \frac{1}{16}$$

The fourth factor is the audio outlet area A_{T}. The transmission type speaker box will have good performance when the audio outlet area A_{T} is equal to ⅛, 1/16, or 1/32 times the speaker effective vibration area (A_{O}). The audio outlet area A_{T} is expressed as:

$${A}_{T} = X \times {A}_{O} ( {cm}^{2} ) ( {cm}^{2} ) ; X = \frac{1}{8} , \frac{1}{16} , \frac{1}{32}$$

It can be seen from the aforementioned design formula of three different types of speaker boxes that regardless of whatever type of speaker box is adopted, when the loudspeaker unit is fixed (and so are the relevant factors of the speaker fixed), in the system (the speaker plus the speaker box), the lowest resonant frequency F_{BO} is inversely proportional to the volume of the speaker box V_{B}. That is the object of lowering the lowest resonant frequency of the system can be achieved by increasing the volume of the speaker box. The invention provides a telescopic speaker box which freely adjusts,the volume of the speaker box to improve the lowest resonant frequency of the speaker box and make the bass effect generated by the speaker box sound rich, heavy and deep. The above disclosures are further elaborated in the first embodiment and the second embodiment.

First Embodiment

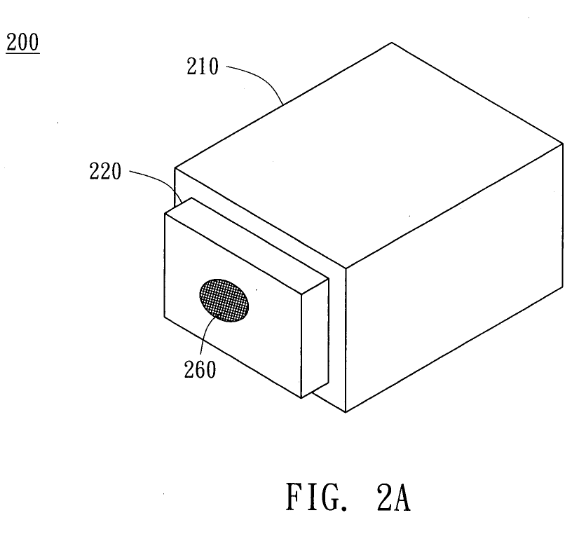

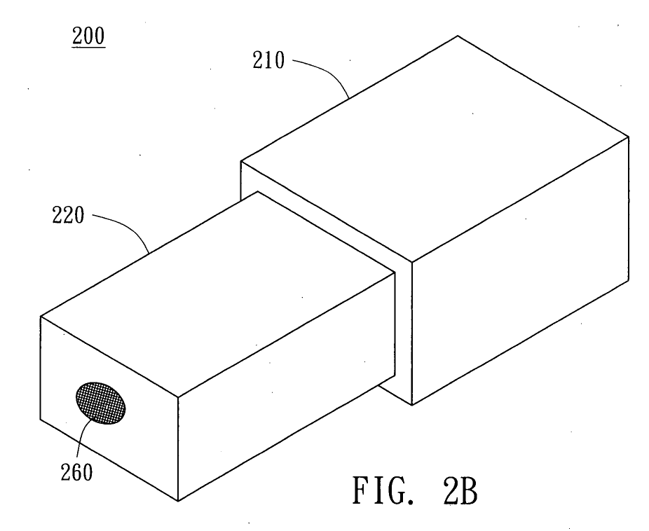

Referring to FIG. 2A, a schematical diagram of a speaker box being at an unextended state according to a first embodiment of the invention is illustrated. The telescopic speaker box 200 is applicable to an electronic apparatus having an electronic apparatus body or an audio player. The telescopic speaker box 200 is disposed on one side of the electronic apparatus body. Examples of the electronic apparatus include a notebook computer. Examples of the audio player include a loudspeaker. The telescopic speaker box 200 comprises a first speaker box sleeve 210 and a second speaker box sleeve 220. The first speaker box sleeve 210 is connected to the second speaker box sleeve 220. The second speaker box sleeve 220 is received inside the first speaker box sleeve 210 to form a speaker box housing of the telescopic speaker box 200. The second speaker box sleeve 220 is a concealed type speaker box. When the telescopic speaker box 200 is at an unextended state, most part of the second speaker box sleeve 220 is disposed inside the first speaker box sleeve 210.

Referring to FIG. 2B, a schematical diagram of a speaker box being at an extended state according to the first embodiment of the invention is illustrated. When the speaker box housing is to be extended to lower the lowest resonant frequency of the telescopic speaker box 200, the second speaker box sleeve 220 is departed from the first speaker box sleeve 210 to change the relative position between the second speaker box sleeve 220 and the first speaker box sleeve 210. Consequently, the volume of the speaker box housing is increased, and the lowest resonant frequency of the telescopic speaker box 200 is lowered.

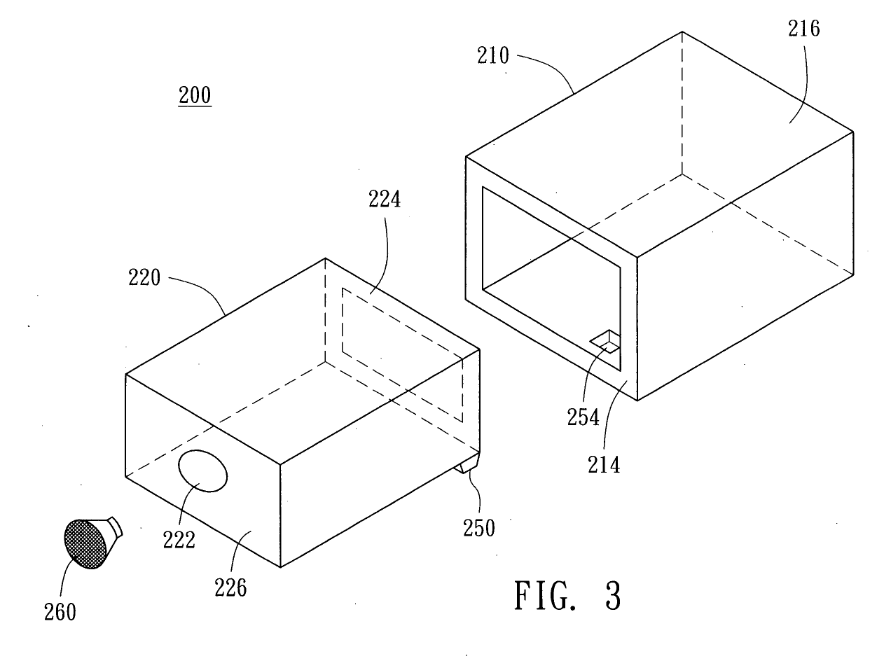

Referring to FIG. 3, a structural diagram of the speaker box according to the first embodiment of the invention is illustrated. Furthermore, the first speaker box sleeve 210 has a first bottom surface 216 and a front end hole 214. The second speaker box sleeve 220 has a second bottom surface 226 and a rear end hole 224. The rear end hole 224 is connected to the front end hole 214. The first bottom surface 216 is opposite to the second bottom surface 226. The area of the second bottom surface 226 is smaller than the area of the first bottom surface 216. The second bottom surface 226 has a hole 222 used for receiving the loudspeaker unit 260. The loudspeaker unit 260 includes a speaker driver. When the lowest resonant frequency of the telescopic speaker box 200 is to be changed, the volume of the telescopic speaker box 200 can be correspondingly changed by adjusting the distance between the first bottom surface 216 and the second bottom surface 226. The telescopic speaker box 200 can generate a relative movement between the first speaker box sleeve 210 and the second speaker box sleeve 220 via a track.

Moreover, the telescopic speaker box 200 can achieve the expected level of the lowest resonant frequency by disposing the second speaker box sleeve 220 at a predetermined position via a positioning device 250. Examples of the positioning device 250 include a positioning pin or a positioning groove. Before the positioning device 250 is moved to the position of the recess 254, the positioning device 250 is flexibly received inside the second speaker box sleeve 220. When the positioning device 250 is moved to the position of the recess 254, the positioning device 250 is ejected from the second speaker box sleeve 220 to become engaged with the recess 254 and position the second speaker box sleeve 220 at the recess 254.

Second Embodiment

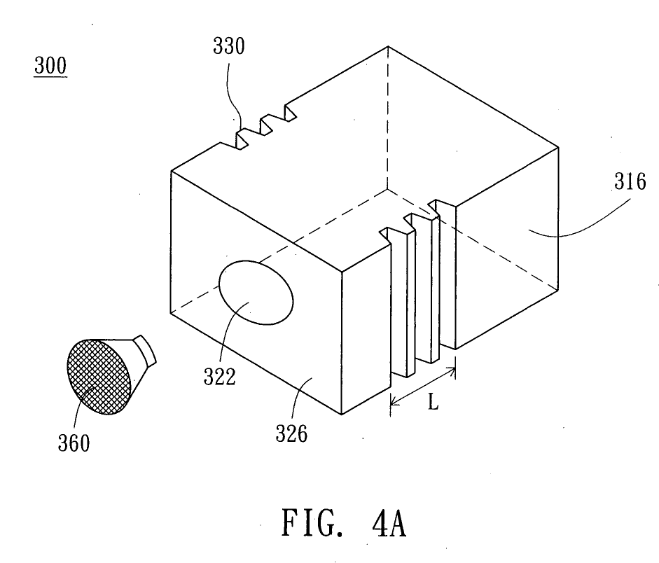

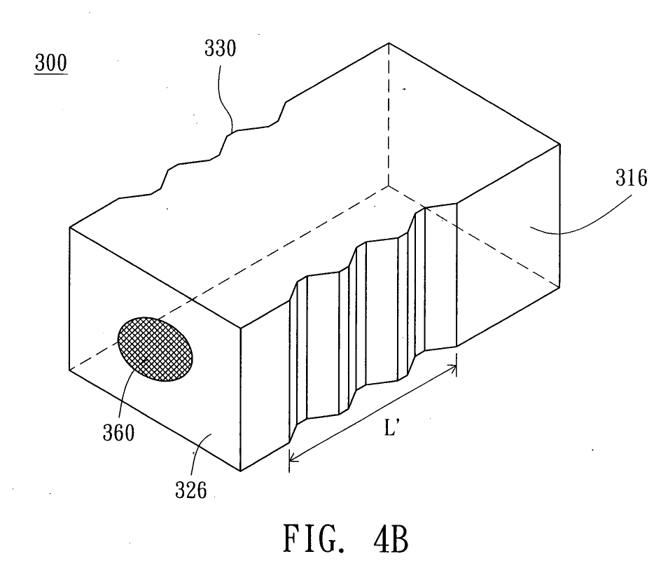

Referring to FIG. 4A, a schematical diagram of a speaker box being at an unextended state according to a second embodiment of the invention is illustrated. The telescopic speaker box 300 is applicable to an electronic apparatus having an electronic apparatus body or an audio player. The telescopic speaker box 200 is disposed on one side of the electronic apparatus body. Examples of the electronic apparatus include a notebook computer. Examples of the voice player include a loudspeaker. The telescopic speaker box 300 has a speaker box housing. The speaker box housing comprises a first bottom surface 316, a second bottom surface 326 and a bellows 330. The first bottom surface 316 is opposite to the second bottom surface 326. The second bottom surface 326 has a hole 322 used for receiving the loudspeaker unit 360. The loudspeaker unit 360 includes a speaker driver. When the telescopic speaker box 300 is at an unextended state, the length of the bellows 330 is L. By adjusting the length of the bellows 330, the volume of the telescopic speaker box 300 is adjusted by moving enabling the first bottom surface 316 closer to or further away from the second bottom surface 326.

Referring to FIG. 4B, a schematical diagram of a speaker box being at an extended state according to the second embodiment of the invention is illustrated. When the lowest resonant frequency of the telescopic speaker box 300 is to be lowered, by prolonging the length of the bellows 310 from L (as shown in FIG. 4A) to L′, the distance between the first bottom surface 316 and the second bottom surface 326 of the telescopic speaker box 300 is increased by moving the first bottom surface 316 further away from the second bottom surface 326, so that the volume of the telescopic speaker box 300 is increased and that the lowest resonant frequency of the telescopic speaker box 300 is lowered.

Not matter the first embodiment using the first speaker box sleeve and the second speaker box sleeve or the second embodiment using the bellows, the lowest resonant frequency of the telescopic speaker box can be lowered by increasing the volume of the telescopic speaker box.

A telescopic speaker box, and an audio player and an electronic apparatus using the same are disclosed in above embodiments of the invention. By increasing the volume of the telescopic speaker box, the lowest resonant frequency of the telescopic speaker box is lowered, so that a broader sound region is generated for enabling the hearer to hear not only the sound of middle to low frequency regions, but also feel the bass effect of heaviness, richness and deepness of the sound of middle to low frequency regions.

The invention is further advantaged by being convenient in portability and economical in space. When using an audio player, the user can extend part of the telescopic speaker box outside the notebook computer to increase the volume of the speaker box. When the audio player is not in use, the extension portion of the telescopic speaker box can be pushed back inside the notebook computer, so that the telescopic speaker box will not occupy additional space inside the notebook computer, providing convenience and portability to the user.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An audio player, comprising:
a loudspeaker unit; and
a telescopic speaker box, comprising:
a speaker box housing whose volume is adjustable, wherein the speaker box housing has a hole for receiving the loudspeaker unit, and by adjusting the volume of the speaker box housing, a lowest resonant frequency of the telescopic speaker box can be achieved.

2. The audio player according to claim 1, wherein the speaker box housing further comprises:
a first speaker box sleeve; and
a second speaker box sleeve received inside and moving with respect to the first speaker box sleeve, wherein the second speaker box sleeve has the hole, the first speaker box sleeve is connected to the second speaker box sleeve, and by adjusting the relative position between the second speaker box sleeve and the first speaker box sleeve, the volume of the speaker box housing is adjusted.

3. The audio player according to claim 2, wherein the first speaker box sleeve has a first bottom surface, the second speaker box sleeve has a second bottom surface, the first bottom surface is opposite to the second bottom surface, the area of the second bottom surface is smaller than the area of the first bottom surface, the second bottom surface has the hole, and by adjusting the distance between the first bottom surface and the second bottom surface, the volume of the speaker box housing is adjusted.

4. The audio player according to claim 2, wherein the first speaker box sleeve has a front end hole, the second speaker box sleeve has a rear end hole, and the rear end hole is connected to the front end hole.

5. The audio player according to claim 2, wherein the telescopic speaker box further comprises a positioning device for positioning the second speaker box sleeve at a predetermined position when a relative movement is generated between the second speaker box sleeve and the first speaker box sleeve.

6. The audio player according to claim 1, wherein the speaker box housing comprises a bellows, and by adjusting the length of the bellows, the volume of the speaker box housing is adjusted.

7. The audio player according to claim 6, wherein the speaker box housing has a first bottom surface and a second bottom surface, the first bottom surface is opposite to the second bottom surface, the second bottom surface has the hole, and by adjusting the distance between the first bottom surface and the second bottom surface, the volume of the speaker box housing is adjusted.

8. An electronic apparatus, comprising:
an electronic apparatus body;
a loudspeaker unit; and
a telescopic speaker box disposed on one side of the electronic apparatus body, comprising:
a speaker box housing whose volume is adjustable, wherein the speaker box housing has a hole for receiving the loudspeaker unit, and by adjusting the volume of the speaker box housing, a lowest resonant frequency of the telescopic speaker box can be achieved.

9. The electronic apparatus according to claim 8, wherein the speaker box housing further comprises:
a first speaker box sleeve; and
a second speaker box sleeve received inside and moving with respect to the first speaker box sleeve, wherein the second speaker box sleeve has the hole, the first speaker box sleeve is connected to the second speaker box sleeve, and by adjusting the relative position between the second speaker box sleeve and the first speaker box sleeve, the volume of the speaker box housing is adjusted.

10. The electronic apparatus according to claim 9, wherein the first speaker box sleeve has a first bottom surface, the second speaker box sleeve has a second bottom surface, the first bottom surface is opposite to the second bottom surface, the area of the second bottom surface is smaller than the area of the first bottom surface, the second bottom surface has the hole, and by adjusting the distance between the first bottom surface and the second bottom surface, the volume of the speaker box housing is adjusted.

11. The electronic apparatus according to claim 9, wherein the first speaker box sleeve has a front end hole, the second speaker box sleeve has a rear end hole, and the rear end hole is connected to the front end hole.

12. The electronic apparatus according to claim 10, wherein the telescopic speaker box further comprises a positioning device for positioning the second speaker box sleeve at a predetermined position when relative movement is generated between the second speaker box sleeve and the first speaker box sleeve.

13. The electronic apparatus according to claim 8, wherein the speaker box housing comprises a bellows, and by adjusting the length of the bellows, the volume of the speaker box housing is adjusted.

14. The electronic apparatus according to claim 13, wherein the speaker box housing has a first bottom surface and a second bottom surface, the first bottom surface is opposite to the second bottom surface, the second bottom surface has the hole, and by adjusting the distance between the first bottom surface and the second bottom surface, the volume of the speaker box housing is adjusted.

15. A telescopic speaker box, comprising:
a speaker box housing whose volume is adjustable, wherein the speaker box housing has a hole for receiving a loudspeaker unit, and by adjusting the volume of the speaker box housing, the lowest resonant frequency of the telescopic speaker box is adjusted.

16. The telescopic speaker box according to claim 15, wherein the speaker box housing further comprising:
a first speaker box sleeve; and
a second speaker box sleeve received inside and moving with respect to the first speaker box sleeve, the second speaker box sleeve has the hole, the first speaker box sleeve is connected to the second speaker box sleeve, and by adjusting the relative position between the second speaker box sleeve and the first speaker box sleeve, the volume of the speaker box housing is adjusted.

17. The telescopic speaker box according to claim 16, wherein the first speaker box sleeve has a first bottom surface, the second speaker box sleeve has a second bottom surface, the first bottom surface is opposite to the second bottom surface, the area of the second bottom surface is smaller than the area of the first bottom surface, the second bottom surface has the hole, and by adjusting the distance between the first bottom surface and the second bottom surface, the volume of the speaker box housing is adjusted.

18. The telescopic speaker box according to claim 16, wherein the first speaker box sleeve has a front end hole, the second speaker box sleeve has a rear end hole, and the rear end hole is connected to the front end hole.

19. The telescopic speaker box according to claim 16, wherein the telescopic speaker box further comprises a positioning device for positioning the second speaker box sleeve at a predetermined position when relative movement is generated between the second speaker box sleeve and the first speaker box sleeve.

20. The telescopic speaker box according to claim 15 wherein the speaker box housing comprises a bellows, and by adjusting the length of the bellows, the volume of the speaker box housing is adjusted.

21. The telescopic speaker box according to claim 20, wherein the speaker box housing has a first bottom surface and a second bottom surface, the first bottom surface is opposite to the second bottom surface, the second bottom surface has the hole, and by adjusting the distance between the first bottom surface and the second bottom surface, the volume of the speaker box housing is adjusted.
